(19) United States
(12) Patent Application Publication
(10) Pub. No.: US 2003/0198739 A1
(43) Pub. Date: Oct. 23, 2003

(54) Anti-stick coatings for reactors

(76) Inventors: Michael Mager, Leverkusen (DE); Christian Mahner, Dormagen (DE); Gerhard Langstein, Kurten (DE)

Correspondence Address: BAYER POLYMERS LLC, 100 BAYER ROAD, PITTSBURGH, PA, 15205, US

(21) Appl. No.: 10/413,937

(22) Filed: Apr. 15, 2003

(30) Foreign Application Priority Data
Apr. 18, 2002 (DE) 10217202.1

(51) Int. Cl. B05D 3/02; C09K 3/00; C04B 35/66; C07G 1/00; C08H 1/00

(52) U.S. Cl. 427/235; 106/38.2; 106/38.22; 106/287.16; 106/287.13; 106/287.14; 427/372.2; 422/131

(57) ABSTRACT

The present invention relates to compositions containing defined sol-gel materials as anti-stick coatings and to apparatus for preparing and processing polymers, such as rubbers, characterized in that they possess such an anti-stick coating containing a hydrophobic sol-gel material.

### FIELD OF THE INVENTION

The present invention relates to the use of compositions containing sol-gel materials as anti-stick coatings and to apparatus for preparing and processing polymers, especially rubbers that possess such an anti-stick coating containing a hydrophobic sol-gel material.

### BACKGROUND OF THE INVENTION

The preparation and processing of polymers is frequently accompanied by deposition of the starting materials used, of the products to be isolated, or of auxiliaries (additives). These deposits then lead, for example, to a marked reduction in the passage of heat through chemical reaction apparatus, and in many cases complete cleaning must be performed after just a single batch. This is extremely costly owing in particular to the shutdown of the plant; moreover, cleaning is frequently associated with hazards, and waste (e.g. contaminated solvent) is produced which must be disposed of accordingly. Furthermore, the deposits themselves may severely adversely affect the quality of the desired product. For example, the dissolution of deposits of changed color, owing to overheating on a heated reactor wall, may impair the entire product.

For the reasons specified above, therefore, the aim is as far as possible to prevent deposits on the apparatus used in the preparation and processing of polymers. Accordingly, EP-A 0 847 404, for example, describes a protective coating (“antifouling material”) for the internal walls of polymerization reactors which reduces the deposition of the polymers. The protective coating is obtained by applying an alkaline solution of an alkylenesulphonic-acid-substituted (hydroxy-)naphthol. The protective coating obtained is yellow to brown and proves very effective towards polyvinyl chloride (virtually no deposits after 1000 reaction batches). When acrylic-nitrilbutadiene-styrene (ABS) and polystyrene were prepared, however, the reactor had to be cleaned in the conventional manner after 50 and 150 loads or batches respectively. As well as the limited number of batches which can be carried out without cleaning of the reactor, the protective coating EP-B-0 847 404 describes has the advantage that it has to be renewed after each polymerization carried out.

It is additionally known that materials based on fluoropolymers, especially those based on polytetrafluoroethylene (Teflon®), can be used as anti-stick coatings. Polymers of that kind, however, are complicated both to prepare and to use. Without appropriate pretreatment they cannot be affixed to metallic substrates such as those of steel, for example (poor adhesion). In many cases a number of additional adhesion-promoting coatings are necessary to achieve this. Moreover, the said polymers frequently suffer incipient dissolution (swelling) by aggressive solvents such as halogenated hydrocarbons and as a result can often not be employed in the context of rubber preparation and processing.

It was an object of the present invention, therefore, to provide apparatus for preparing and processing polymers, on which the deposition of polymers is significantly reduced or prevented by application of an appropriate coating, which, moreover, does not need renewing after each preparation or processing step.

A was also an object of the present invention to provide correspondingly equipped apparatus for preparing and processing rubbers because of the extremely high tendency of rubbers to deposit on the internal walls of corresponding apparatus.

### SUMMARY OF THE INVENTION

It has now surprisingly been found that by coating the said apparatus with a hydrophobic sol-gel material the attachment of polymers, especially of rubbers, is prevented very simply and effectively. In contrast to the state of the art, the coatings need not be applied anew after every processing step (e.g. of polymerization) and are themselves very simple to apply. The coatings are colorless and adhere well to the materials in customary use for chemical apparatus, such as steel or enamel, thereby allowing contamination of the product prepared or processed to be ruled out. The present invention accordingly provides for compositions containing defined sol-gel materials as anti-stick coatings and provides apparatus for preparing and processing polymers, especially rubbers, characterized in that they possess an anti-stick coating containing hydrophobic sol-gel material.

### DETAILED DESCRIPTION OF THE INVENTION

Hydrophobic sol-gel materials for the purposes of the present invention are substantially three-dimensionally crosslinked, organically modified, amorphous glasses which can be obtained by hydrolysis and condensation reactions of low molecular mass compounds, such as silicon alkoxides, for example. Following hydrolysis and condensation the hydrophobic sol-gel materials of the present invention preferably have at least one structural element of the formula (I)

[R¹-(E)ᵢ-]ⱼ-Si[R²ₖ(O_{1/2})₃₋ₖ]₄₋ⱼ (I)

wherein

i is 0 or 1,

j is 1, 2 or 3, and

k is 0, 1 or 2, and

E is oxygen or sulphur, and

R¹ is an optionally substituted alkyl or aryl radical or a bridging alkylene or arylene radical, and

R² is an optionally substituted alkyl or aryl radical.

More preferably the sol-gel materials have a structural element of the formula (II)

[R¹]ⱼ—Si[R²ₖ(O_{1/2})₃₋ₖ]₄₋ⱼ (II)

wherein

j is 1, 2 or 3, and

k is 0, 1 or 2, and

R¹ is a bridging C₁ to C₈ alkylene radical, and

R² is an optionally substituted alkyl or aryl radical.

Most preferably the sol-gel materials have a structural element of the formula (III)

[R¹]ⱼ—Si[R²ₖ(O_{1/2})₃₋ₖ]₄₋ⱼ (III)

wherein

j is 1,

k is 0, 1 or 2, and

R¹ is a bridging C₁ to C₄ alkylene radical, and

R² is a methyl or ethyl radical.

For preparing sol-gel materials of the formulae (I), (II) or (III) in which R¹ is an alkylene radical it is preferred to use polyfunctional organosilanes. For the purposes of the present invention polyfunctional organosilanes include monomers, oligomers and/or polymers wherein that at least two silicon atoms having hydrolyzable and/or condensation-crosslinking groups are attached by way of, in each case, at least one Si C bond, preferably at least one alkylene group (—CH₂—), to a structural unit which links the silicon atoms. Polyfunctional organosilanes having at least 3 or, better still, at least 4 silicon atoms having hydrolzable and/or condensation-crosslinking groups are particularly preferred. Particularly suitable hydrolyzable groups which, following hydrolysis and condensation, eventually give the radicals Si(O_{1/2}) in the stated formulae (I), (II) or (III) are alkoxy or aryloxy groups; preferably mention may be made of alkyloxy groups, such as methyloxy, ethyloxy, propyloxy or butyloxy. Condensation-crosslinking groups are, in particular silanol groups (Si—OH). As linking structural units for the purposes of the invention mention may be made both of individual atoms and of molecules. Molecular structural units may, for example, be linear or branched C₁-C₂₀ alkylene chains, C₅-C₁₀ cycloalkylene radicals or C₆-C₁₂ aromatic radicals, such as phenyl, naphthyl or biphenyl radicals, for example. The said radicals may be singly or multiply substituted and may in particular also contain heteroatoms, such as Si, N, P, O or S, for example, within the chains or rings.

Coatings possessing the desired chemical resistance are obtained if the linking structural unit of the polyfunctional organosilanes is composed of linear, branched, cyclic or cage-form carbosilanes, carbosiloxanes or siloxanes. Examples of such polyfunctional organosilanes are shown in the general formulae (IV), (V) and (VI).

[(R³O)₃₋ₐ(R⁴)ₐSi(CH₂)ₑ]_{c}—X—[(CH₂)_{f}Si(OR⁵)_{3-b}(R⁶)_{b}]_{d} (IV)

in which

R³, R⁴, R⁵ and R⁶ independently of one another are C₁-C₈ alkyl radicals or phenyl radicals, preferably methyl, ethyl or phenyl radicals,

a and b independently of one another are 0, 1 or 2, preferably 0 or 1, and also

c and d and, respectively, e and f independently of one another are greater than or equal to 1, preferably greater than or equal to 2, and

X as a bridging structural unit is a linear, branched, cyclic or cage-form siloxane, carbosilane or carbosiloxane, preferably a cyclic or cage-form siloxane, carbosilane or carbosiloxane.

Preference is given to using cyclic carbosiloxanes of the general formula (V),

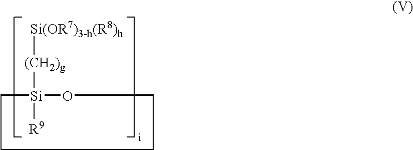

in which

R⁷, R⁸ and R⁹ independently of one another are C₁-C₄ alkyl radicals,

h is 0, 1 or 2, preferably 0 or 1, and also

g is an integer from 1 to 4, preferably 2, and

i is an integer from 3 to 10, preferably 4, 5 or 6.

Suitable cyclic carbosiloxanes include compounds of the formulae (VIa) to (VIe), in which R¹⁰ is methyl or ethyl:

(VIa) cyclo-{OSi[(CH₂)₂Si(OH)(CH₃)₂]}₄

(VIb) cyclo-{OSi[(CH₂)₂Si(OR¹⁰)(CH₃)₂]}₄

(VIc) cyclo-{OSi[(CH₂)₂Si(OH)₂(CH₃)]}₄

(VId) cyclo-{OSi[(CH₂)₂Si(OR¹⁰)₂(CH₃)]}₄

(VIe) cyclo-{OSi[(CH₂)₂Si(OR¹⁰)₃]}₄.

The oligomers of the stated cyclic carbosiloxanes, which are disclosed in WO 98/52992 (page 2), may of course also be used in the process of the invention as polyfunctional organosilanes. It is likewise possible to use mixtures of different cyclic monomeric or else oligomeric carbosiloxanes.

The sol-gel coating solution is prepared, for example, by mixing suitable low molecular mass compounds in a solvent, after which the hydrolysis and/or condensation reaction is initiated by adding water and optionally catalysts. The conduct of such sol-gel operations is known in principle to the person skilled in the art. For example, the syntheses of polyfunctional organosilanes and organosiloxanes, and processes for preparing corresponding sol-gel coating solutions from which, in turn, the sol-gel materials of formula (III) can be obtained, are described in EP-A 0 743 313, EP-A 0 787 734 and WO-A 98/52992.

The apparatus for preparing and processing rubbers coated with the sol-gel material according to the present invention are prepared by

a) by applying appropriate sol-gel coating solutions by customary methods,

b) evaporating volatile constituents such as solvents and condensation products

c) and curing, where appropriate at elevated temperatures, to give, finally, the coating of the hydrophobic sol-gel material.

Application may take place by any customary method, such as dipping, spraying, flooding, spin coating, knife coating or pouring, it being possible for the substrate to be coated over its entire surface or only over parts thereof. The use of sol-gel coating solutions has the advantage that, owing to their normally very low viscosity and good adhesion to steel, for example, it is possible to coat the interior of apparatus of complex shape for preparing and processing rubbers. For example, existing reactions and/or pipelines can be coated by passing the sol-gel coating solution through them, evaporating the volatile constituents and curing, for example in an optionally hot stream of air or inert gas (e.g. nitrogen). On the application of such coatings see, for example, Organic Coatings: Science and Technology, John Wiley & Sons 1994, Chapter 22, pages 65-82.

Since there is generally no need to pretreat the apparatus such as by applying an adhesion primer, for example, application may take place directly after appropriate cleaning of the surface to be coated.

Typical materials of which the apparatus of the present invention may be composed are metals or enamels, preferably ferrous metallic materials, more preferably steels.

The apparatus of the present invention equipped with a hydrophobic sol-gel material are particularly suitable for the preparation and processing of rubbers such as butyl and bromo- and chlorobutyl rubber, polybutadienes, acrylonitrile butadiene rubber, hydrogenated acrylonitrile-butadiene rubber, chloroprene rubber, ethylene vinyl acetate rubber, butadiene rubber, styrene-butadiene rubber, ethylene-propylene.

Most preferably, they can be used for preparing and processing polybutadienes, chloroprenes and ethylene-propylene rubbers, and also butyl rubber.

The rubbers may be prepared by all established processes, examples being the processes described in more detail below. Examples of solvents which can be used here include organic compounds (or isomer mixtures thereof), such as hexane, cyclohexane, benzene, methylene chloride, toluene or industrial mixtures such as DHN 50 (50-70% by weight n-hexane+5-10% by weight cyclohexane+25-35% by weight methylcyclopentane, 0-5% by weight 2-methylpentane, 0-10% by weight 3-methylpentane) from Exxsol. Because of the good thermal stability and adhesion of the coatings to the internal walls of the apparatus, preparation and processing can be carried out at temperatures from −40 to 150° C., and pressures from 0.1 to 6 bar.

By way of example, the following processes for preparing various rubbers may be described:

Chloroprene

Chloroprene is prepared by addition reaction of chlorine with butadiene (Distillers process). The reaction produces a mixture of 1,2- and 1,4-dichlorobutene. After isomerization of 1,4-dichlorobutene to 1,2-dichlorobutene, 2-chloro-1,3-butadiene is obtained by HCl elimination. See also F. Röthemeyer/F. Sommer “Kautschuktechnologie” Hanserverlag 2001, pp.150-152.

The industrial polymerization of chloroprene takes place in an aqueous emulsion by the free-radical mechanism at temperatures between 10 and 45° C. Emulsifiers used are resin acids, NaOH and the Na salt of a condensation product of formaldehyde and naphthalenesulphonic acid. The polymerization is initiated by potassium persulfate or by redox systems. Because of the high reactivity of chloroprene, gelling occurs at conversion rates of just 30% by weight. By adding regulators (thiols, xanthogen disulphide or sulphur) it is possible to reduce the gel content. The polymerization is terminated by inhibitors such as thiuram disulphide and tert-butylpyrocatechol, for example.

The excess monomer is removed and recovered by steam distillation in vacuum. The degassed latex is adjusted with acid to a pH of about 6.0 and coagulated on a freeze roll (−15° C.). The rubber film is stripped off, washed and dried.

The rubbers are classified as follows in accordance with the regulators used:

| | |
|---|---|
| Homopolymers: | mercaptan- and xanthogenate-modified types |
| Copolymers: | sulphur-modified types |

Butyl Rubber

The monomers isobutylene and isoprene are recovered from the C₄ and C₅ cuts, respectively, in the preparation of naphtha.

Butyl rubber is prepared by cationic copolymerization with isobutylene with small amounts of isoprene (0.5-2.5% by weight) in solution. The isoprene units are randomly distributed within the copolymer. See also F. Röthemeyer/F. Sommer “Kautschuktechnologie” Hanserverlag 2001, pp. 136-146.

The growth reaction of the cationic polymerization proceeds very rapidly. Consequently, the molar mass is dependent to an unusually large extent on the polymerization temperature. The molar mass increases inversely to the temperature. Polymerization of isobutylene at room temperature produces oligomers, since the chain transfer reaction is dominant. Only at low temperatures (approximately −90° C.) are long-chain polymer chains obtained. Suitable solvents include weakly polar, e.g. chlorinated, hydrocarbons (methylene chloride, chloroform). Catalysts used are Lewis acids such as AlCl₃ or BF₃, for example, which are activated by small amounts of cocatalysts (water, acids). 1-Butene acts as a regulator but at the same time deactivates a catalyst.

The industrial copolymerization of isobutylene and isoprene is carried out in methylene chloride at temperatures of −100° C. The monomer concentration is 25% by weight and the catalyst used is AlCl₃. The cooled monomer mixture (isobutylene and 0.5-3% by weight isoprene) and the catalyst in solution in methylene chloride are supplied to a continuous reactor. The polymerization proceeds very rapidly even at −100° C. Polybutylene is insoluble in methylene chloride and is obtained as a suspension (precipitation polymerization). The polymerization suspension is withdrawn continuously, and hot water is added. Solvent and monomer residues are removed by stripping and after distillative separation are resupplied to the operation. The polymer suspension is admixed with a stabilizer and with a mixture of stearic acid and zinc stearate (0.4-1% by weight). Stearates are used in order to avoid particle agglomeration. In a second stage, the residual hydrocarbons are removed in vacuum. Dewatering takes place using an extruder. The dry crumbs are then compressed to form bales.

EPDM

The monomers ethylene and propylene are obtained from natural gas or from crude petroleum spirit by cracking; the termonomers are prepared by chemical synthesis. See also F. Röthemeyer/F. Sommer “Kautschuktechnologie” Hanserverlag 2001, pp. 122-123.

The solution polymerization takes place in aliphatic hydrocarbons (pentane, hexane) at slightly elevated temperatures (30-60° C.) continuously in stirred cascades. Owing to the large differences in reactivity between the monomers, propene is used in excess while ethene and the diene component are metered in continuously. The Ziegler-Natta catalyst is added as a dilute solution. Efficient cooling is necessary in order to remove the considerable heat of polymerization, which is 2500 kJ per kg of polymer. Since the copolymer is soluble in hexane, excessive viscosities are avoided by terminating the reaction after conversion of about 8-10% by weight, by adding water or carboxylic acids. In order to avoid side reactions (oxidation, gelling), the residues of catalyst must be washed out. Solvents and residual monomers are expelled by steam distillation. Thereafter the polymer is separated off, dried and compressed to form bales. The molar mass is adjusted by way of the amount of catalyst and using regulators. The suspension polymerization (precipitation polymerization) is carried out in liquid propene, using the heat of evaporation of the propene for cooling. Catalyst, ethylene and/or termonomer are metered continuously to the suspension medium (propene). The copolymer formed is insoluble in propylene and is obtained as a suspension. The suspension process permits substantially higher conversions (up to 30% by weight) and the preparation of polymers with a higher molar mass. The molar masses are regulated by adding hydrogen (hydride transfer). In the gas phase process (since 1996), ethylene, propylene and/or the termonomer are supplied continuously to a fluid bed reactor. The catalyst is added directly to the fluid bed. The gaseous monomers serve to fluidize the polymer particles and to remove the heat of polymerization.

Polybutadiene/SBR

Butadiene can be polymerized anionically, coordinatively or free-radically. Anionic and coordinative polymerization take place in solution, free-radical polymerization in emulsion. Industrially, polybutadiene is prepared using lithium-alkylene or Ziegler-Natta catalysts. The resulting polymers differ in their microstructure (cis, trans and vinyl content). See also F. Röthemeyer/F. Sommer “Kautschuktechnologie” Hanserverlag 2001, pp. 81-85+104-107.

The polymerization with Li-alkylene is carried out in solution and proceeds in accordance with an anionic mechanism. Aliphatic or cycloalipatic hydrocarbons are used as solvents. The monomer concentrations amount to between 10-20% by weight, the reaction temperature lies between 30-120° C. Lower temperature produce linear products, higher temperatures branch products. The molar mass depends only on the molar ratio of monomer to catalyst (no termination reaction). However, the polymerization can be terminated deliberately by adding chain stoppers (water, acids). The microstructure depends on the nature of the alkali metal and on the polarity of the solvent.

The coordinative polymerization of butadiene with Ziegler-Natta catalysts takes place in solution. To avoid high viscosities the monomer fraction is limited to 10-15% by weight. Polymerization takes place in a series of stirred autoclaves under inert atmosphere. Hydrogen is used as molar mass regulator. When the planned conversion has been achieved, the catalyst is deactivated and the monomer is protected by adding stabilizers. The commercially available Ziegler-Natta polybutadienes are prepared with the following catalyst systems: titanium, cobalt, nickel, neodymium. The resultant polymers feature a high cis content.

The free-radical polymerization of butadiene is conducted in an aqueous emulsion. Catalysts used include redox systems (hydroperoxide, Na formaldehyde-sulphonate and Fe(II) complexes), emulsifiers used include fatty acids and resin acids.

The copolymerization of styrene and butadiene in solution takes place in accordance with an anionic mechanism in solution. Owing to the large difference in copolymerization parameters, the polymerization of butadiene takes place first, and only then is followed by that of styrene. This produces block copolymers having a defined transition region. By adding polar components (e.g. THF, tetramethylenediamine) the copolymerization parameters are altered so that styrene can be incorporated randomly.

SBR can also be carried out with free-radical initiation as an emulsion polymerization.

The degree of branching can be influenced by the reaction temperature. In the so-called cold polymerization process (T=5° C.) only a small extent of branching comes about. In the hot polymerization process (T=40-50° C.) branched or precrosslinked polymer chains are formed. In the case of free-radical polymerization, the monomer units are arranged randomly within the polymer as it forms. Emulsion polymerization has the advantage that in thermal terms it is readily controllable. Industrial preparation takes place in continuous stirred tank cascades. Styrene, butadiene, regulators and emulsifier system are dispersed in water and pumped continuously through the reactors, which are cooled to 5° C. Initiators used are water-soluble peroxides, such as p-methane hydroperoxide, for example, which are activated using a redox system. The average residence time in the reactor is 8-10 hours. When a conversion of 60-65% by weight has been reached, termination is accomplished by adding a free-radical scavenger (e.g. dimethyl dithiocarbamate). The latex produced after the residual monomers have been separated off (vacuum+steam) has a solids content of approximately 65% by weight.

Acrylonitrile-Butadiene Rubbers

Copolymers of butadiene and acrylonitrile are also referred to as nitrile rubber. They are of great importance for the production of products resistant to fats, oils and motor fuels. See also F. Röthemeyer/F. Sommer “Kautschuktechnologie” Hanserverlag 2001, pp.107-109.

Acrylonitrile-butadiene rubber (NBR) is supplied with different acrylonitrile fractions as solid rubber and in the form of latex.

Acrylonitrile is predominantly prepared by reacting propylene with oxygen and ammonia.

Nitrile rubber is prepared by free-radical copolymerization of butadiene and acrylonitrile in an aqueous emulsion. Depending on polymerization temperature a distinction is made here between hot and cold polymerization processes, the latter being employed with preference. Emulsifiers used include fatty acids (lauric, palmitic, oleic acid), resin soaps (disproportionated abietic acid) or alkyl-arylsulphonic acids. The latter reduce the soiling of the vulcanizing moulds. Initiators used are either alkali metal persulphates or organic peroxides with reducing agent (redox systems). Acrylonitrile can be copolymerized with butadiene in any proportion. The acrylonitrile content of the commercially customary rubbers varies between 15 and 50% by weight.

The molar mass is adjusted using regulators (alkyl mercaptans); in order to avoid chain branching, the polymerization is terminated at a conversion of 70-80% by adding chain stoppers (Na hydrogen sulphide). The excess monomers are removed in vacuum with steam, recovered and used again. To improve the storage stability and to prevent cyclization reactions during the mixing operation, slightly discoloring stabilizers (amines) and/or non-discoloring stabilizers (sterically hindered phenols) are added to the NBR latex.

The invention is further illustrated but is not intended to be limited by the following examples in which all parts and percentages are by weight unless otherwise specified.

### EXAMPLES

The carbosiloxanes cyclo-{OSi[(CH₂)₂SiOH(CH₃)₂]}₄ and (oligomeric) cyclo-{OSi[(CH₂)₂Si(OC₂H₅)₂CH₃]}₄ were prepared as described in U.S. Pat. No. 5,880,305 and U.S. Pat. No. 6,136,939 respectively. All other components were available commercially and were used without further purification.

### Example 1

### Preparation of the Sol-Gel Material 1 for Coating Apparatus

a) 8.3 g of cyclo-{OSi[(CH₂)₂SiOH(CH₃)₂]}₄ dissolved in 17.6 g of 1-methoxy-2-propanol were admixed with stirring with 10.7 g of tetraethylorthosilicate and 1.8 g of a 0.1 N aqueous solution of p-toluenesulphonic acid. After one hour of stirring, finally, a further 4.4 g of 1-methoxy-2-propanol were added for dilution and 0.04 g of Tegoglide 410, supplied by Goldschmidt, was added as leveling additive. A clear and colorless coating solution of low viscosity with a pot life of more than 5 hours was obtained.

b) The batch described under a) was repeated with 139.6 g of cyclo-{OSi[(CH₂)₂SiOH(CH₃)₂]}₄ 295.5 g of 1-methoxy-2-propanol, 180.1 g of tetraethyl orthosilicate 30.4 g of a 0.1 N aqueous solution of p-toluenesulphonic acid, 74.0 g of 1-methoxy-2-propanol and 0.7 g of Tegoglide 410, giving a corresponding coating solution.

### Example 2

### Preparation of the Sol-Gel Material 2 for Coating Apparatus

139.6 g of cyclo-{OSi[(CH₂)₂SiOH(CH₃)₂]}₄ dissolved in 295.5 g of 1-methoxy-2-propanol were admixed with stirring with 180.1 g of tetraethyl orthosilicate and 30.4 g of a 1 N aqueous solution of p-toluenesulphonic acid. After one hour of stirring, finally, a further 74.0 g of 1-methoxy-2-propanol were added for dilution; however, the addition of a leveling additive was not carried out, in order not to influence the surface properties of the resultant film as a result of the additive. As in Example 1b), a clear and colorless coating solution of low viscosity having a pot life of more than 5 hours was obtained.

### Example 3

### Internal Coating of a Steel Pipe with Sol-Gel Material According to Example 1b)

200 g of a sol-gel coating solution prepared according to Example 1b) were introduced into a steel pipe which was closed at one end and had a diameter of about 7 cm and a length of about 1.5 m. After the coating solution had been introduced the side still open was sealed and the pipe was rotated about its own axis for about 5 minutes. Then the sealed end was opened, the coating solution was drained and the steel pipe was stored at ambient temperature for 15 hours. Finally, a stream of hot air at about 80° C. was passed through for 1 hour, as a result of which the sol-gel coating was further hardened. The result of visual examination was that the steel pipe was uniformly provided with an optically flawless coating (coat thickness approximately 5 μm).

### Example 4

### Coating of Steel Sheet with the Sol-Gel Material 1a) and Testing of the Adhesion Tendency with Respect to a Rubber Solution

Two commercially customary steel sheets with a smooth surface were spin coated (500 rpm, 20 seconds) with the sol-gel solution from Example 1a). After brief flashing off at room temperature (about 10 minutes), the coating was finally cured at 80° C. for one hour and then at 130° C. for one hour. An optically flawless film was obtained.

Then 1 ml of an approximately 10% strength by weight rubber solution (butyl rubber in n-hexane) was added to the coated side of each steel sheet, and after brief flashing off at room temperature (about 10 minutes) the sheets were heated at 70° C. for one hour (forced-air drying oven). For comparison, an uncoated steel plate was treated with the rubber solution in the same way.

After cooling to room temperature, the rubber could be removed effortlessly and completely from the coated steel sheets, while from the untreated steel sheet it could be detached only by scratching with the fingernail, in fragments.

### Example 5

### Coating of Steel Sheet with the Sol-Gel Material 1a) and Testing of the Resistance to Dichloromethane

By testing the pencil hardness in accordance with ASTM the mechanical strength of the coatings produced according to Example 4 on the steel sheets was investigated first of all. Using a pencil of hardness “2H”, no damage was found.

Thereafter the steel plates were immersed for 24 hours in dichloromethane (technical grade); finally, the pencil hardness was tested again. The optically unchanged coatings (no cracks, blisters or detachment) gave the pencil hardness “2H” again; in other words, even storage in this aggressive solvent did not result in damage to the coating.

### Example 6

### Coating of Steel Sheets of the Sol-Gel Materials from Example 1b) and 2) and also Testing of the Anti-Stick Effect in the Context of EPDM Processing

a) Coating of the steel sheet with a smooth surface: the sol-gel coating solution prepared in accordance with Example 1b) was introduced into an appropriate dip tank, then at constant speed a steel sheet (approximately DIN A4 format) was immersed and withdrawn again. After brief flashing off at room temperature (about 10 minutes), the coating, finally, was cured at 130° C. in a forced-air drying oven.

The coat thickness of the optically flawless film was approximately between 6 and 8 μm, the adhesion was excellent (cross-cut test in accordance with ISO 2409).

b) Coating of a steel panel with a rough surface: the coating described in 6a) with the sol-gel coating solution from Example 1b) was repeated, but in this case a steel sheet having a rough surface was used. The average depth of roughness was approximately 50 μm.

c) In accordance with the process described in Example 6b) a further rough steel sheet was coated, using for this purpose the sol-gel coating solution from Example 2). Curing gave an optically flawless coating having a coat thickness of approximately 8-10 μm.

d) Testing of the effectiveness in the context of EPDM processing:

The metal test sheets produced in accordance with Example 6a), 6b) and 6c) were investigated for their anti-stick effect in a plant for the drying of EPDM (dryer line). The test was conducted under extreme production conditions, i.e. at a temperature of about 120° C. and a wet EPDM dispersion pH of less than 1. For comparison, a commercial coating system of Teflon® and an uncoated, smooth VA-grade steel plate was tested under the same conditions. In a first screening, the sheets were mounted for about 24 hours in the running product stream, directly at the adhesion-critical entry to the application chamber. The dryer entry point is known to be the most problematic site for sticking in the workup process. By sensorial testing of the surfaces of the sheets (adhesion of the rubber particles), sticking ratings in the range 1-5 (very low sticking, 1, to very severe sticking, 5) were awarded.

As is evident from Table 1 below, a sticking rating of 2 was obtained with the best commercial coating (Teflon@), while the uncoated smooth steel sheet showed very severe attachment of rubber particles (sticking rating 5).

With the sol-gel material coatings of the invention, very good sticking ratings (2) were achieved both on smooth and on rough substrates. Surprisingly, with the coatings of the invention it is therefore possible to achieve, despite substantially simpler processing, an anti-stick effect, which is just as good as that, achieved with Teflon®.

TABLE 1

| Sample | | Average depth | | Sticking |
|---|---|---|---|---|
| number | Type | of roughness | Coating | rate |
| 1 | Comparative | smooth | None | 5 |
| | sample | | | |
| 2 | Comparative | 50 μm | Teflon ® | 2 |
| | sample | | | |
| 3 | Coating | Smooth | Sol-gel material from | 2 |
| | according | | Example 6a) | |
| | to the | | | |
| | present | | | |
| | invention | | | |
| 4 | Coating | 50 μm | Sol-gel material from | 2 |
| | according | | Example 6b) | |
| | to the | | | |
| | present | | | |
| | invention | | | |
| 5 | Coating | 50 μm | Sol-gel material from | 2 |
| | according | | Example 6c) | |
| | to the | | | |
| | present | | | |
| | invention | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An anti-stick coating composition for an apparatus for preparing and producing polymers comprising at least one structural element of the formula (I)
[R¹-(E)ᵢ-]ⱼ-Si[R²ₖ(O_{1/2})₃₋ₖ]₄₋ⱼ (I)
wherein
i is 0 or 1,
j is 1, 2 or 3,
k is 0, 1 or 2,
E is oxygen or sulphur,
R¹ is an optionally substituted alkyl or aryl radical or a bridging alkylene or arylene radical, and
R² is an optionally substituted alkyl or aryl radical.

2. An anti-stick coating composition for an apparatus for preparing and producing polymer compositions according to claim 1, wherein the coating composition comprises at least one structural element of the formula (II)
[R¹]ⱼ—Si[R²ₖ(O_{1/2})₃₋ₖ]₄₋ⱼ (II)
wherein
j is 1, 2 or 3,
k is 0, 1 or 2,
R¹ is a bridging C₁ to C₈ alkylene radical, and
R² is an optionally substituted alkyl or aryl radical.

3. An anti-stick coating composition for an apparatus for preparing and producing polymer compositions according to claim 1, wherein the coating composition comprises at least one structural element of the formula (III)
[R¹]ⱼ—Si[R²ₖ(O_{1/2})₃₋ₖ]₄₋ⱼ (III)
wherein
j is 1,
k is 0, 1 or 2,
R¹ is a bridging C₁ to C₄ alkylene radical, and
R² is a methyl or ethyl radical.

4. A process for coating an apparatus for preparing or processing polymers, with an anti-stick coating composition comprising the steps of:
applying a sol-gel coating solution comprising at least one structural element of the formula (I)
[R¹-(E)ᵢ-]ⱼ-Si[R²ₖ(O_{1/2})₃₋ₖ]₄₋ⱼ (I),
wherein
i is 0 or 1,
j is 1, 2 or 3,
k is 0, 1 or 2,
E is oxygen or sulphur,
R¹ is an optionally substituted alkyl or aryl radical or a bridging alkylene or arylene radical, and
R² is an optionally substituted alkyl or aryl radical to an apparatus, evaporating volatile constituents off the apparatus, curing the solution to the apparatus.

5. A process for coating an apparatus for preparing or processing polymers according to claim 4, wherein the coating solution comprises at least one structural element of the formula (II)
[R¹]ⱼ—Si[R²ₖ(O_{1/2})₃₋ₖ]₄₋ⱼ (II)
wherein
j is 1, 2 or 3,
k is 0, 1 or 2,
R¹ is a bridging C₁ to C₈ alkylene radical, and
R² is an optionally substituted alkyl or aryl radical.

6. A process for coating an apparatus for preparing or processing polymers according to claim 5, wherein the coating solution comprises at least one structural element of the formula (III)
[R¹]—Si[R²ₖ(O_{1/2})₃₋ₖ]₄₋ⱼ (III)
wherein
j is 1,
k is 0, 1 or 2,
R¹ is a bridging C₁ to C₄ alkylene radical, and
R² is a methyl or ethyl radical.

7. An apparatus for preparing or processing polymers, coated with an anti-stick coating composition comprising at least one structural element of the formula (I)
[R¹-(E)ᵢ-]ⱼ-Si[R²ₖ(O_{1/2})₃₋ₖ]₄₋ⱼ (I)
wherein
i is 0 or 1,
j is 1, 2 or 3,
k is 0, 1 or 2,
E is oxygen or sulphur,
R¹ is an optionally substituted alkyl or aryl radical or a bridging alkylene or arylene radical, and
R² is an optionally substituted alkyl or aryl radical.

8. An apparatus for preparing or processing polymers, according to claim 7, wherein the coating composition comprises at least one structural element of the formula (II)
[R¹]ⱼ—Si[R²ₖ(O_{1/2})₃₋ₖ]₄₋ⱼ (II)
wherein
j is 1, 2 or 3,
k is 0, 1 or 2,
R¹ is a bridging C₁ to C₈ alkylene radical, and
R² is an optionally substituted alkyl or aryl radical.

9. An apparatus for preparing or processing polymers, according to claim 8, wherein the coating compositions comprises at least one structural element of the formula (III)
[R¹]ⱼ—Si[R²ₖ(O_{1/2})₃₋ₖ]₄₋ⱼ (III)
wherein
j is 1,
k is 0, 1 or 2,
R¹ is a bridging C₁ to C₄ alkylene radical, and
R² is a methyl or ethyl radical.
